(19) United States
(12) Patent Application Publication
(10) Pub. No.: US 2026/0110867 A1
(43) Pub. Date: Apr. 23, 2026

(54) SECURE OPTICAL COMMUNICATIONS CABINET FOR USE IN DATA CENTER APPLICATIONS

(71) Applicant: CORNING RESEARCH & DEVELOPMENT CORPORATION, Corning, NY (US)

(72) Inventors: Ray Samuel Barnes, JR., Hickory, NC (US); Karyne Poissant Prevratil, Fort Worth, TX (US); Diana Rodriguez, Mansfield, TX (US)

(21) Appl. No.: 19/319,067

(22) Filed: Sep. 4, 2025

Related U.S. Application Data
(60) Provisional application No. 63/710,202, filed on Oct. 22, 2024.

(51) Int. Cl. G02B 6/44

(52) U.S. Cl. CPC G02B 6/4452

(57) ABSTRACT

The present disclosure relates to an optical communications cabinet that provides a greater number of secure housings within the optical communications cabinet. The optical communications cabinet includes a rack section comprising a plurality of housings and a cable manager section that comprises a plurality of cable pathways where each cable pathway leads to a corresponding single housing of the plurality of housings. The optical communications cabinet further includes a jumper manager section that is configured to route cables for optical connectors.

### PRIORITY APPLICATION

This application claims the benefit of priority of U.S. Provisional Application No. 63/710,202, filed on Oct. 22, 2024, the content of which is relied upon and incorporated herein by reference in its entirety.

### FIELD OF THE INVENTION

This disclosure relates generally to an optical communications cabinet and more particularly, to a secure optical communications cabinet with an increased number of securable housings within the optical communications cabinet.

### BACKGROUND OF THE INVENTION

The large growth of the Internet has led businesses and other organizations to develop large scale data centers for organizing, processing, storing and/or disseminating large amounts of data. Data centers contain a wide range of information technology (IT) equipment including, for example, servers, networking switches, routers, storage systems, etc. Data centers further include a large amount of cabling and cabinets to organize and interconnect the IT equipment in the data center. Modern data centers may include multi-building campuses having, for example, one primary or main building and a number of auxiliary buildings in close proximity to the main building. IT equipment in the buildings on the campus is typically interconnected by one or more local fiber optic networks. Other types of data centers include: a multi-tenant data center.

In multi-tenant data centers, optical communications cabinets allow for providers to house optical equipment and bring internet service to the location. In this environment, multiple different carriers bring service to the location, and as such, security is required within the optical communications cabinet to prevent entanglement and tampering of other carrier's equipment. Typical optical communications cabinets that are used in this instance are referred to as a “quarter cabinet.” Typical quarter cabinets allow for 4 carriers per cabinet in a 3 feet by 4 feet amount of floor space as shown in FIG. 10.

There is a need to provide an optical communications cabinet that will accommodate more carriers per the same footprint/floor space. Improvements in the foregoing are desired.

### SUMMARY OF THE INVENTION

The present disclosure relates to an optical communications cabinet that provides a greater number of secure housings within the optical communications cabinet. The optical communications cabinet includes a rack section comprising a plurality of housings and a cable manager section that comprises a plurality of cable pathways where each cable pathway leads to a corresponding single housing of the plurality of housings. The optical communications cabinet further includes a jumper manager section that is configured to route cables for optical connectors.

In one embodiment, an optical communications cabinet is provided. The optical communications cabinet comprising: a rack section comprising: a plurality of housings, wherein each housing is separate from the other housings; and a cable manager section adjacent to and coupled to the rack section, the cable manager section comprising a plurality of cable pathways corresponding to the number of housings such that each cable pathway leads to the corresponding housing.

In another embodiment, each cable pathway comprises a lead-in section configured to guide a cable to the corresponding housing. In another embodiment, each cable pathway is configured to house up to three cables. In another embodiment, the cable manager section comprises ten cable pathways and the rack section comprises ten housings. In another embodiment, each housing occupies a 4U space within the optical communications cabinet. In another embodiment, an optical communications cabinet system is provided. The optical communications cabinet system comprising: a first optical communication cabinet; and a second optical communication cabinet adjacent to the first optical communication cabinet, the second optical communication cabinet comprising: a second rack section comprising: a second plurality of housings, wherein each second housing is separate from the other second housings; and a second cable manager section adjacent to and coupled to the second rack section, the second cable manager section comprising a plurality of second cable pathways corresponding to the number of second housings such that each second cable pathway leads to the corresponding second housing. In another embodiment, wherein the plurality of housings of the first optical communications cabinet and the second plurality of housings of the second optical communications cabinet each comprise ten housings.

In one embodiment, an optical communication cabinet is provided. The optical communication cabinet comprising: a rack section comprising: a plurality of housings, wherein each housing is separate from the other housings; a cable manager section adjacent to and coupled to a first side of the rack section, the cable manager section comprising a plurality of cable pathways corresponding to the number of housings such that each cable pathway leads to the corresponding housing; and a jumper manager section adjacent to a second side of the rack section such that the rack section is positioned between the cable manager section and the jumper manager section.

In another embodiment, the jumper manager section comprises a plurality of fiber routing fingers, wherein the number of fiber routing fingers corresponds to the number of housings. In another embodiment, the optical communication cabinet further comprising: a first door coupled to the optical communication cabinet, wherein the first door covers the rack section and the cable manager section when in a closed position; and a second door coupled to the optical communication cabinet, wherein the second door covers the jumper manager section in a closed position. In another embodiment, each cable pathway comprises a lead-in section configured to guide a cable to the corresponding housing. In another embodiment, each cable pathway is configured to house up to three cables. In another embodiment, the cable manager section comprises ten cable pathways and the rack section comprises ten housings. In another embodiment, each housing occupies a 4U space within the optical communications cabinet.

In one embodiment, an optical communications cabinet system is provided. The optical communications cabinet system comprising: a first optical communication cabinet comprising: a first rack section comprising a first plurality of housings, wherein each first housing is separate from the other first housings; a first cable manager section adjacent to and coupled to a first side of the first rack section, the first cable manager section comprising a first plurality of cable pathways corresponding to the number of first housings such that each first cable pathway leads to the corresponding first housing; and a first jumper manager section adjacent to a second side of the first rack section such that the first rack section is positioned between the first cable manager section and the first jumper manager section; and a second optical communication cabinet adjacent to the first optical communication cabinet, the second optical communication cabinet comprising: a second rack section comprising a second plurality of housings, wherein each second housing is separate from the other second housings; a second cable manager section adjacent to and coupled to a first side of the second rack section, the second cable manager section comprising a second plurality of cable pathways corresponding to the number of second housings such that each second cable pathway leads to the corresponding second housing; and a second jumper manager section adjacent to a second side of the second rack section such that the second rack section is positioned between the second cable manager section and the second jumper manager section.

In another embodiment, the optical communication cabinet system, further comprising: a first door coupled to the first optical communication cabinet, wherein the first door covers the first rack section and the first cable manager section when in a closed position; a second door coupled to the first optical communication cabinet, wherein the second door covers the first jumper manager section in a closed position; a third door coupled to the second optical communication cabinet, wherein the third door covers the second rack section and the second cable manager section when in a closed position; and a fourth door coupled to the second optical communication cabinet, wherein the fourth door covers the second jumper manager section in a closed position. In another embodiment, the first optical communication cabinet is adjacent to the second optical communication cabinet such that the optical communication cabinet system has a width of about 3 feet and a length of about 4 feet. In another embodiment, each cable pathway of the first cable manager section and the second cable manager section comprises a lead-in section configured to guide a cable to the corresponding first housing or second housing. In another embodiment, each of the first cable manager section and the second cable manager section comprises ten cable pathways and each of the first rack section and the second rack section comprises ten housings. In another embodiment, each of the first housings and each of the second housings occupy a 4U space within the optical communications cabinet system.

Further areas of applicability of the present invention will become apparent from the detailed description provided hereinafter. It should be understood that the detailed description and specific examples, while indicating example preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a perspective view of an example optical communications cabinet in accordance with the present disclosure;

FIG. 2 is a perspective view of the optical communications cabinet of FIG. 1 with doors removed to illustrate interior components of the optical communications cabinet;

FIG. 3 is an isolated, perspective view of a cable manager section of the optical communications cabinet of FIG. 1;

FIG. 4 is a top view of the cable manager section of FIG. 3;

FIG. 5 is an expanded perspective view of a portion of the cable manager section of FIG. 3 illustrating a cable restraining feature;

FIG. 6 is a perspective view of a portion of the optical communications cabinet of FIG. 2 illustrating a rack portion of the optical communications cabinet;

FIG. 6A is an expanded, front view of a housing within the rack portion of the optical communications cabinet;

FIG. 7 is a front view of the optical communications cabinet of FIG. 2; and

FIG. 8 is a perspective view of a fiber routing member within a jumper manager section of the optical communications cabinet of FIG. 1;

FIG. 9 is a perspective view of an optical communications cabinet system in accordance with the present disclosure;

FIG. 9A is a perspective view of an alternate optical communications cabinet system in accordance with the present disclosure; and

FIG. 9B is a front view of the alternate optical communications cabinet system of FIG. 9A illustrating how optical cables and optical fibers are routed within the alternate optical communications cabinet system of FIG. 9A; and

FIG. 10 is a perspective view of a conventional optical communications cabinet.

### DETAILED DESCRIPTION

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

The present disclosure relates to an optical communications cabinet that provides a greater number of secure housings within the optical communications cabinet. The optical communications cabinet includes a rack section comprising a plurality of housings and a cable manager section that comprises a plurality of cable pathways where each cable pathway leads to a corresponding single housing of the plurality of housings. The optical communications cabinet further includes a jumper manager section that is configured to route cables for optical connectors.

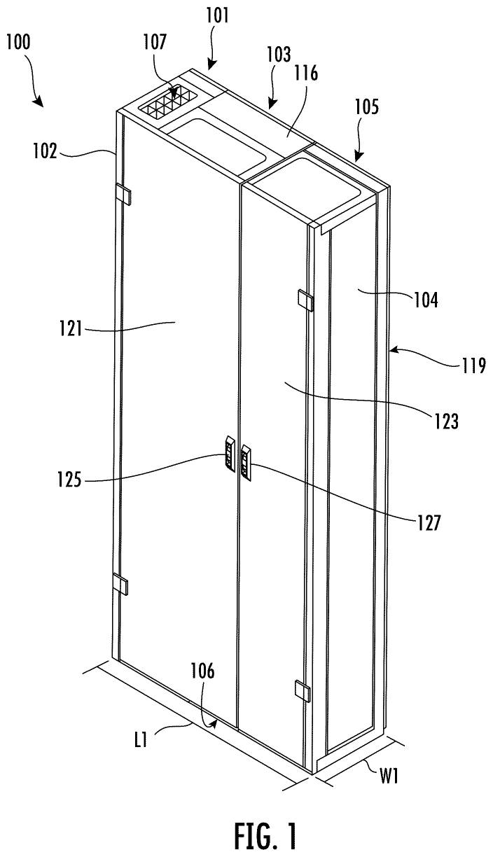

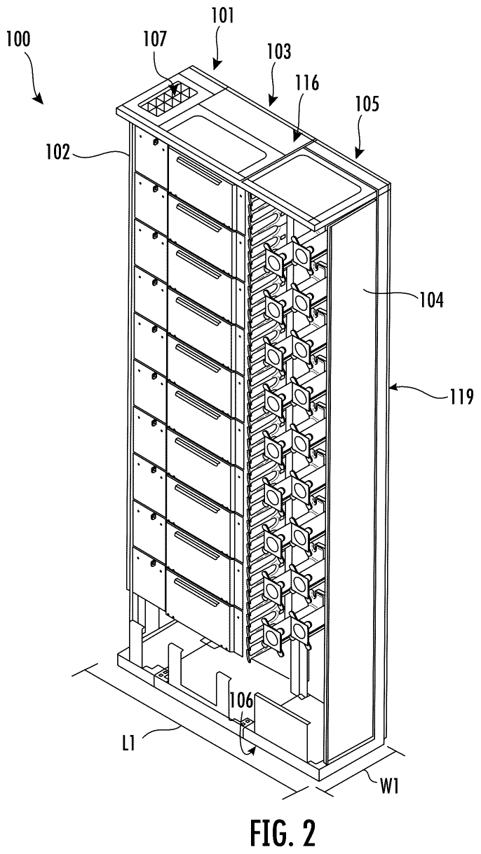

Referring first to FIGS. 1 and 2, an optical communications cabinet 100 is shown. Optical communications cabinet 100 is configured to house optical communications equipment such as optical cables, optical fibers, etc. in various environments such as multi-tenant data centers for example. In particular, optical communications cabinet 100 provides secure access to particular sections of the optical communications cabinet 100 for various carriers. In this way, the carriers can only access their specific section of the optical communications cabinet 100 without interacting with other carriers'respective sections as discussed in greater detail herein. As shown, optical communications cabinet includes a bottom panel 106, a top panel 116, a back panel 119, and side panels 102, 104 to define an interior of the optical communications cabinet 100.

Optical communications cabinet 100 includes a first door 121 and a second door 123 which limit access to an interior of optical communications cabinet 100. Each door 121, 123 has a handle 125, 127, respectively, that are independently locked within optical communications cabinet 100 and provide access to certain sections of optical communications cabinet 100. In particular, first door 121 encloses a cable manager section 101 and a rack section 103, and second door 123 encloses a jumper manager section 105. As mentioned previously, doors 121, 123 are independently locked within optical communications cabinet 100 so as to provide specific access to the jumper manager section 105 to specific individuals (such as an overall optical communications cabinet manager, for example). Stated another way, this configuration limits carrier technician access to the cable manager section 101 and the rack section 103 and prevents the carrier technician from altering the jumper manager section 105.

In some embodiments, optical communications cabinet 100 has a width W1 of about 1.5 feet and a length L1 of about 4 feet. However, it is within the scope of the present disclosure that alternate suitable dimensions may be used.

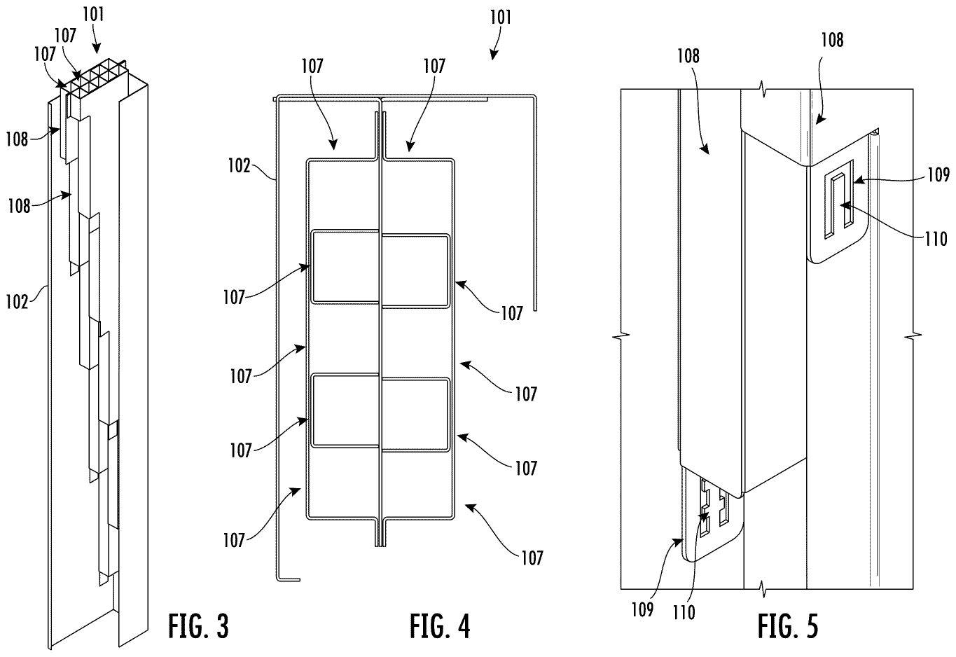

Optical communications cabinet 100 comprises cable manager section 101, rack section 103, and jumper manager section 105. Cable manager section 101 comprises a self-contained section of the optical communications 100 that is adjacent to the rack section 103. Referring now to FIGS. 3-5, cable manager section 101 comprises a plurality of cable pathways 107 that are separate, self-contained from the rack section 103 and that correspond to the number of housings 111. Stated another way, there is the same number of cable pathways 107 and the number of housings 111. As shown in FIG. 2, there are ten (10) housings 111, and as such, there are ten (10) cable pathways 107 (FIG. 4) with each cable pathway 107 leading to one of the ten (10) housings 111 as discussed below. It is within the scope of the present disclosure that in alternate embodiments, alternate numbers of housings 111 and cable pathways 107 may be used within optical communications cabinet 100.

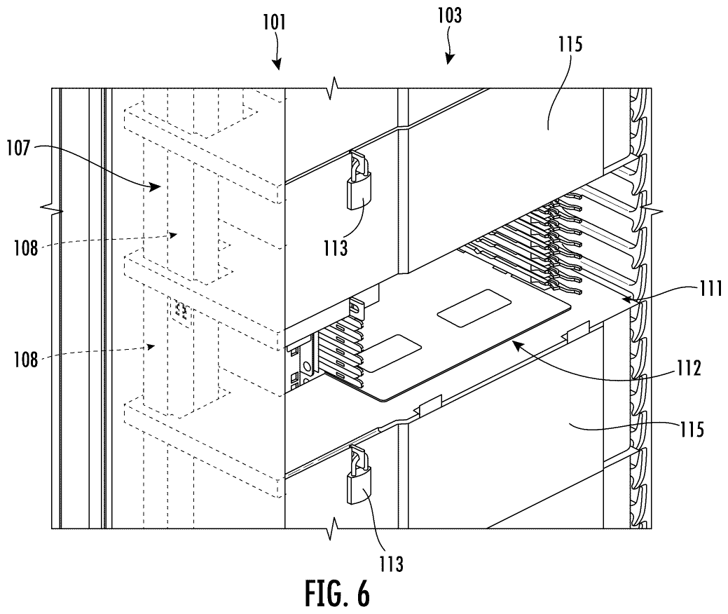

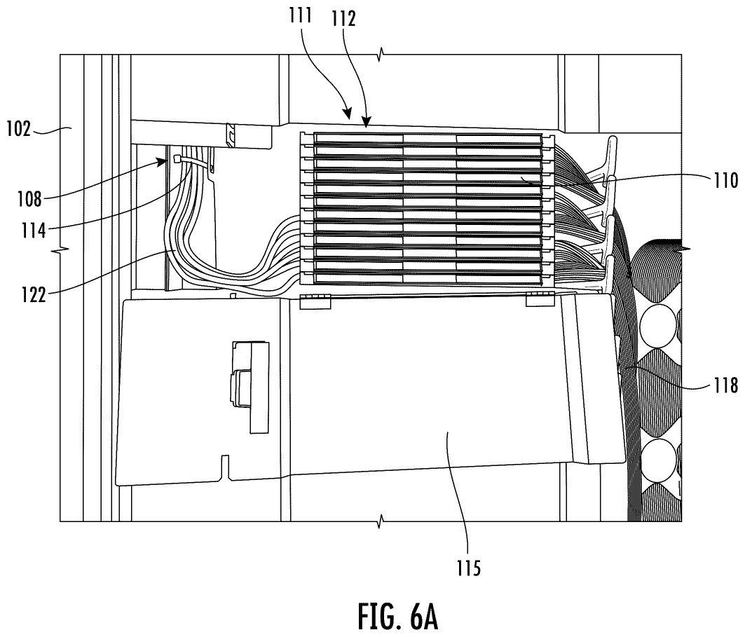

As mentioned previously, each cable pathway 107 leads to the corresponding housing 111. In particular, each cable pathway 107 comprises a lead-in section 108 that is configured to guide optical cables that are fed through cable pathway 107 to a specific level or location of the corresponding housing 111 within optical communications cabinet 100. When the fed optical cables (through lead-in section 108) are at the specific level or location of the corresponding housing 111, the optical cables are then moved into the housing 111 of rack section 103 as shown in FIG. 6A. Referring back to FIG. 3, each lead-in section 108 has a different length extending downward from top panel 116 to the specific level or location of the corresponding housing 111 within optical communications cabinet 100. In addition, as shown, each lead-in section 108 is enclosed such that a physical barrier is provided among the lead-in sections 108 to prevent interaction and tangling of the optical cables that are fed through each specific cable pathways 107 designated for a specific housing 111. In this way, optical cable(s) that are fed into cable manager section 101 are directed to the corresponding level or location of the corresponding housing 111 (within optical communications cabinet 100) limiting the potential of the optical cable(s) being routed to the incorrect housing and/or limiting the potential entanglement among optical cables that are designated for different housings 111. In some embodiments, each cable pathway 107 can hold up to three (3) optical cables. However, it is within the scope of the present disclosure, that alternate number of optical cables may be inserted into each cable pathway 107.

Referring briefly to FIG. 4, cable pathways 107 are arranged in a 5×2 arrangement to accommodate ten (10) housings 111 in optical communications cabinet 100. However, it is within the scope of the present disclosure that alternate configurations of cable pathways 107 based on spatial constraints of optical communications cabinet 100.

Referring now to FIG. 5, each lead-in section 108 includes a cable retention structure 109 between the housing 111 and the lead-in section 108. Cable retention structure 109 includes a notched section 110 from which an attachment structure 114 (FIG. 6A) (e.g., zip ties, etc.) can be attached and coupled to the optical cable(s) to hold the optical cable(s) in place as the optical cable(s) are turned from the lead-in section 108 of cable pathway 107 into the housing 111.

As mentioned previously, optical cables and optical fibers are fed into housings 111. With reference to FIG. 6, housing 111 comprises a space 112 in which optical components 110 are housed. In particular, in some embodiments, optical components 110 (FIG. 6A) include fiber optic trays, fiber optic modules, fiber optic cassettes, fiber optic splice components, or the like. In some embodiments, housing 111 occupies a 4U space where each U space comprises a height of 1.75 inches (4.45 cm) and comprises a width of 19 inches or 23 inches. However, it is within the scope of the present disclosure that alternate housing sizes may be used. In some embodiments, the optical components 110 that are housed within housing 111 may be configured to support a fiber optic connection density of at least ninety-eight (98), at least one hundred twenty (120), or at least one hundred forty-four (144) fiber optic connections per U space based on using LC-type fiber optic components. However, it is within the scope of the present disclosure that alternate connection densities and/or alternate connection types may be used within housing 111.

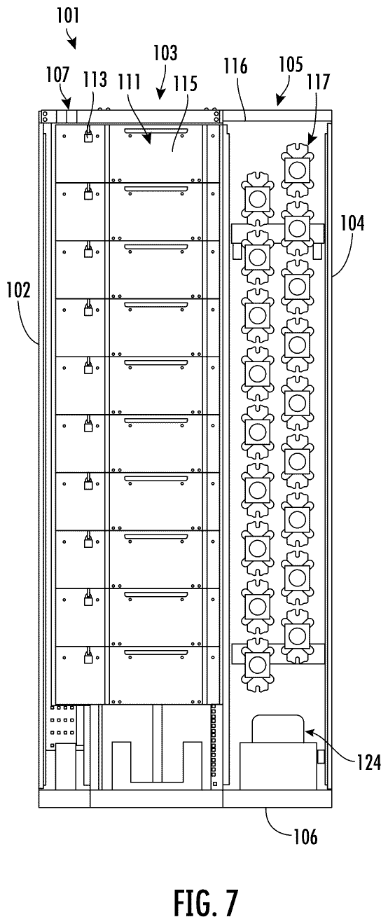

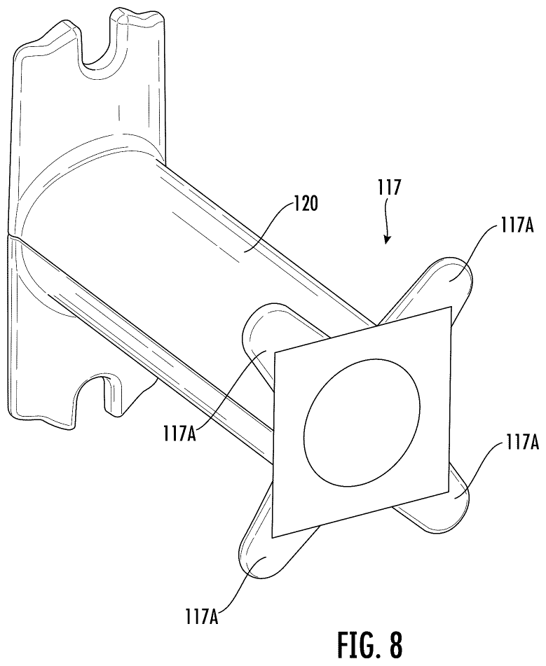

As shown in FIGS. 6 and 7, each housing 111 comprises a cover 115 that spans and covers the lead-in section 108 and the housing 111. Each cover 115 includes a lock 113 that is meant to provide selective access to lead-in section 108 and housing 111. In this way, operators (e.g., technicians of carrier networks) can only access their specific section of the lead-in section 108 and housing 111 without affecting optical components 110 of other carriers in other housings 111 and/or lead-in sections 108.

As mentioned previously, optical communications cabinet 100 includes a jumper manager section 105 that is adjacent to the rack section 103. Jumper manager section 103 provides optical fiber connectors whose optical fibers (within optical cables 118 (FIG. 6A)) are spliced with the optical fibers (within optical cables 122 (FIG. 6A)) within optical components 110 (e.g., splice cassette) of housing 111 from lead-in section 108. Optical cables 118 are routed within jumper manager section 105 by a plurality of fiber routing fingers 117. Fiber routing fingers 117 are configured to route optical cables 118 within jumper manager section 105 prior to leading optical connectors out of optical communications cabinet 100 to an end point (e.g., an end point within a patch panel, an end point within another optical communications cabinet. etc.) as discussed in greater detail herein. Fiber routing fingers 117 comprise a central member 120 about which optical cables 118 can be wrapped and a plurality of fingers 117A at an end of the central member 120. Fingers 117A provide an outer boundary for optical cables 118 provide containment of optical cables 118 along the central member 120 thereby, preventing entanglement of optical cables 118 with other optical cables 118 from other housings 111 within jumper manager section 108.

Jumper manager section 105 also includes an opening 124 as shown in FIG. 7. Opening 124 enables optical cables 118 (and the optical fibers within optical cables 118) to be routed through opening 124 and into another optical communications cabinet 100′ to establish a cross connection between the optical communications cabinets 100, 100′. In some embodiments, optical cables 118 (and the optical fibers within optical cables 118) are routed through opening 124 to an end point that is exterior to optical communications cabinet 100 (e.g., patch panel, etc.). In some embodiments, while opening 124 is provided within jumper manager section 105, optical cables 118 (and optical fibers within optical cables 118) are routed past the top panel 116 to an end point exterior of the optical communications cabinet 100 (e.g., patch panel, etc.).

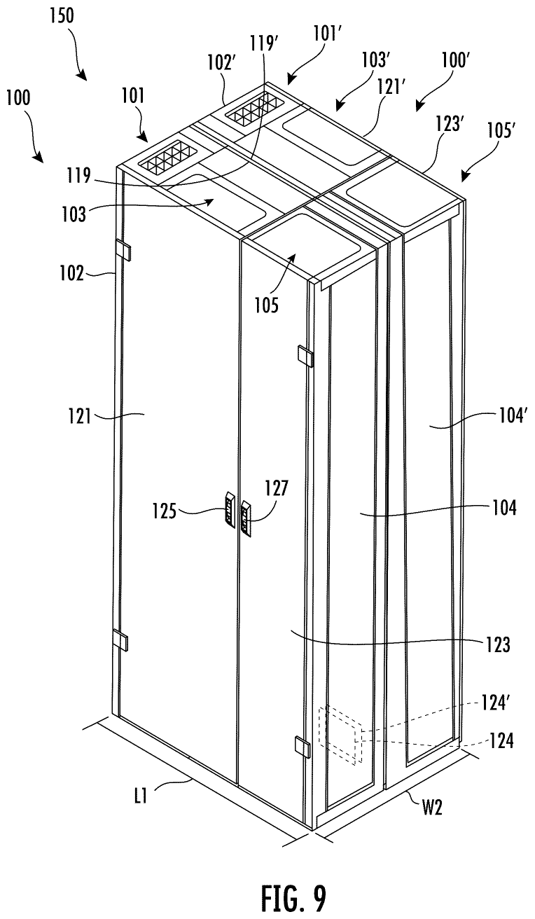

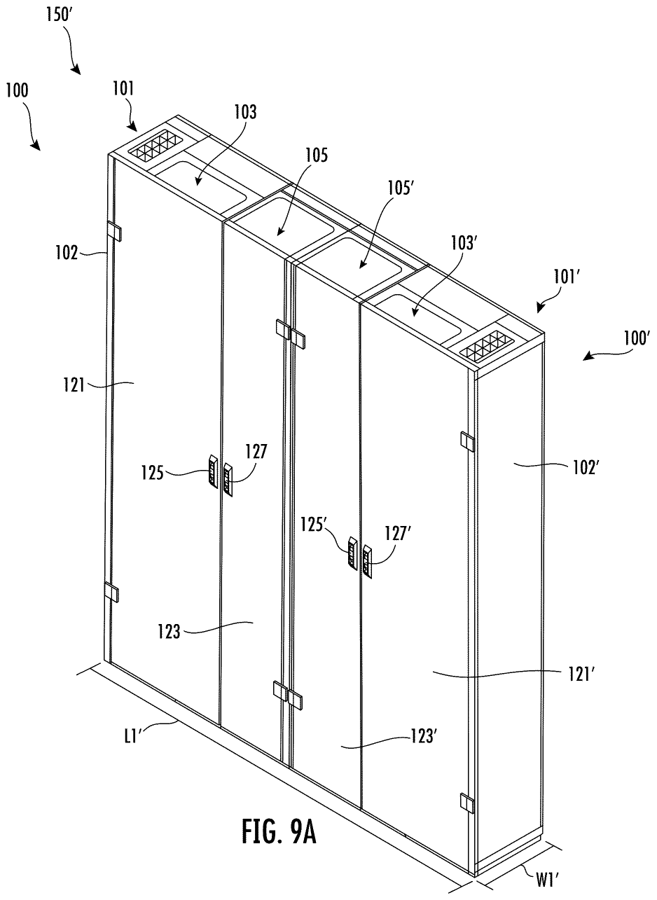

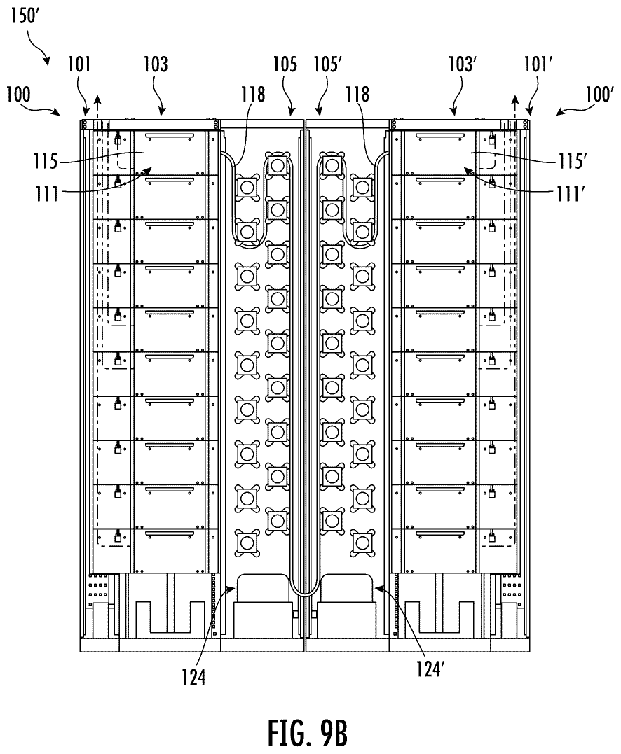

Optical communications cabinet 100 can be coupled to another optical communications cabinet 100′ to increase the density of housings 111, 111′ within an optical communications system 150 as described below. Referring to FIG. 9, optical communication cabinet system 150 is shown where optical communication cabinet system 150 comprises optical communication cabinet 100 and optical communication cabinet 100′ that are positioned adjacent to each other. Optical communication cabinet 100′ is substantially the same as optical communication cabinet 100 and like reference numbers refer to like parts except with the prime indicator (′) added thereto. In the configuration shown, optical communication cabinets 100, 100′ are positioned such that back panels 119, 119′ are adjacent to each other as shown. As mentioned previously, optical cables 118 within jumper manager section 105 can be routed between optical communications cabinets 100, 100′ to establish a cross connection between the optical communications cabinet 100, 100′. In particular, optical cables 118 are routed through opening 124 of optical communications cabinet 100 and through opening 124′ of optical communications cabinet 100′ such that optical cables 118 can be routed to an end point within optical communications cabinet 100′.

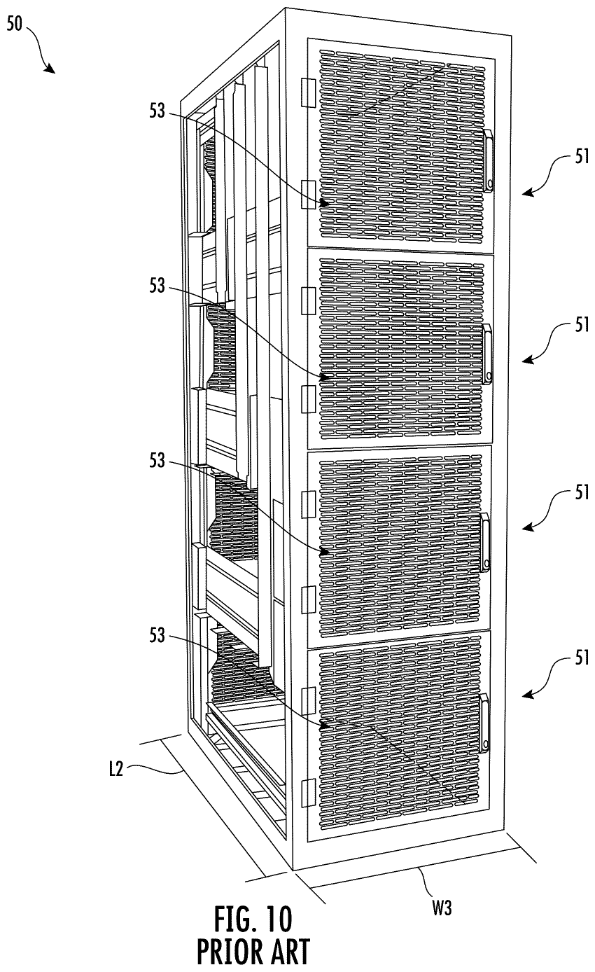

In this configuration, optical communication cabinet system 150 has a length L1 of about 4 feet and width W2 of about 3 feet, which is about the same dimensions of conventional optical communications cabinet 50 (FIG. 10). In this embodiment, optical communications cabinet system 150 includes twenty (20) housings between housings 111, 111′ of optical communications cabinets 100, 100′ and provides separate access for up to twenty (20) different carriers as compared to the four (4) provided in the conventional optical communication cabinet 50 in about the same footprint.

Referring to FIG. 9A, an alternate embodiment of optical communications cabinet system 150′ is shown. In this embodiment, optical communications cabinet system 150′ comprises optical communications cabinet 100 adjacent to optical communications cabinet 100′ where side panels 104, 104′ are removed such that jumper manager sections 105, 105′ are adjacent to each other and optical cables 118 can be routed between optical communications cabinets 100, 100′.

As shown in FIG. 9B, optical cables 118 can be routed between optical communications cabinets 100, 100′ to establish a cross connection between the optical communications cabinets 100, 100′. In particular, optical cables 118 are routed through the opening between optical communications cabinets 100, 100′ due to the absence of side panels 104, 104′ such that optical cables 118 can be routed to an end point within optical communications cabinet 100′. While a single optical cable 118 and corresponding cable routing path for optical cable 118 is shown in FIG. 9B, it is within the scope of the present disclosure that alternate cable routing paths for optical cables 118 may be used within each optical communications cabinet 100, 100′ (within each of jumper manager sections 105, 105′) and within optical communication cabinet system 150′.

In this configuration, optical communication cabinet system 150′ has a length L1′ of about 8 feet and width W1′ of about 1.5 feet, which occupies about the same area as conventional optical communications cabinet 50 (FIG. 10) (i.e., about the same footprint as conventional optical communications cabinet 50) despite the different in configuration of the optical communications cabinets 100, 100′ relative to each other. In this embodiment, optical communications cabinet system 150′ includes twenty (20) housings between housings 111, 111′ of optical communications cabinets 100, 100′ and provides separate access for up to twenty (20) different carriers as compared to the four (4) provided in the conventional optical communication cabinet 50 in about the same footprint.

Referring now to FIG. 10, typical optical communications cabinets 50 have a width W3 of about 3 feet and a length L2 of about 4 feet. As shown, typical optical communications cabinets 50 include about four (4) housings 51 in which all optical communications equipment such as optical cables, fiber optic equipment (e.g., cassettes, modules, etc.), and optical fiber connectors are housed. In this configuration, it can be difficult for technicians to access a particular component during servicing as the technician would need to open door 53 to access the interior of housing 51 and then potentially navigate to various depths within housing 51 to access and manage a particular optical component needing service.

By contrast and advantageously, optical communications cabinet 100 and optical communications cabinet system 150 provide a greater density of housings 111 within the same footprint of conventional optical communications cabinet 50 (i.e., more housings 111 within the same footprint of typical optical communications cabinet 50). In particular, the optical communications cabinet 100 of the present disclosure provides ten (10) housings in a smaller footprint (W1 is less than W3) as opposed to four (4) housings as described above. In addition, optical communications cabinet system 150 provides twenty (20) housings 111 in the same footprint (optical communications cabinet system 150 occupies about the same area as conventional optical communications cabinet 50 as shown in FIGS. 9 and 9A) as opposed to four (4) housings of optical communications cabinet 50 described above. In this way, a greater number of carrier networks can be accommodated in the same footprint reducing cost and increasing overall spatial efficiency within a data center.

Moreover, by segmenting optical communications cabinet 100 into a cable manger section 101, a rack section 103, and a jumper manager section 105 as disclosed herein, a technician can more easily access a particular section of the optical communications cabinet 100 depending on which aspect of the optical communication system needs to be accessed, and this configuration limits the possibility of a technician affecting other optical components within the optical communications cabinet 100 and/or optical communications cabinet system 150.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended to be construed to limit the present invention or otherwise to exclude any such other embodiments, adaptations, variations, modifications and equivalent arrangements.

What is claimed is:

1. An optical communications cabinet comprising:
a rack section comprising: a plurality of housings, wherein each housing is separate from the other housings; and
a cable manager section adjacent to and coupled to the rack section, the cable manager section comprising a plurality of cable pathways corresponding to the number of housings such that each cable pathway leads to the corresponding housing.

2. The optical communications cabinet of claim 1, wherein each cable pathway comprises a lead-in section configured to guide a cable to the corresponding housing.

3. The optical communications cabinet of claim 1, wherein each cable pathway is configured to house up to three cables.

4. The optical communications cabinet of claim 1, wherein the cable manager section comprises ten cable pathways and the rack section comprises ten housings.

5. The optical communications cabinet of claim 4, wherein each housing occupies a 4U space within the optical communications cabinet.

6. An optical communications cabinet system, comprising:
a first optical communication cabinet of claim 1; and
a second optical communication cabinet adjacent to the first optical communication cabinet, the second optical communication cabinet comprising:
a second rack section comprising: a second plurality of housings, wherein each second housing is separate from the other second housings; and
a second cable manager section adjacent to and coupled to the second rack section, the second cable manager section comprising a plurality of second cable pathways corresponding to the number of second housings such that each second cable pathway leads to the corresponding second housing.

7. The optical communications cabinet of claim 6, wherein the plurality of housings of the first optical communications cabinet and the second plurality of housings of the second optical communications cabinet each comprise ten housings.

8. An optical communication cabinet comprising:
a rack section comprising: a plurality of housings, wherein each housing is separate from the other housings;
a cable manager section adjacent to and coupled to a first side of the rack section, the cable manager section comprising a plurality of cable pathways corresponding to the number of housings such that each cable pathway leads to the corresponding housing; and
a jumper manager section adjacent to a second side of the rack section such that the rack section is positioned between the cable manager section and the jumper manager section.

9. The optical communication cabinet of claim 8, wherein the jumper manager section comprises a plurality of fiber routing fingers, wherein the number of fiber routing fingers corresponds to the number of housings.

10. The optical communication cabinet of claim 8, further comprising:
a first door coupled to the optical communication cabinet, wherein the first door covers the rack section and the cable manager section when in a closed position; and
a second door coupled to the optical communication cabinet, wherein the second door covers the jumper manager section in a closed position.

11. The optical communication cabinet of claim 8, wherein each cable pathway comprises a lead-in section configured to guide a cable to the corresponding housing.

12. The optical communication cabinet of claim 8, wherein each cable pathway is configured to house up to three cables.

13. The optical communication cabinet of claim 8, wherein the cable manager section comprises ten cable pathways and the rack section comprises ten housings.

14. The optical communication cabinet of claim 13, wherein each housing occupies a 4U space within the optical communications cabinet.

15. An optical communications cabinet system comprising:
a first optical communication cabinet comprising:
a first rack section comprising a first plurality of housings, wherein each first housing is separate from the other first housings;
a first cable manager section adjacent to and coupled to a first side of the first rack section, the first cable manager section comprising a first plurality of cable pathways corresponding to the number of first housings such that each first cable pathway leads to the corresponding first housing; and
a first jumper manager section adjacent to a second side of the first rack section such that the first rack section is positioned between the first cable manager section and the first jumper manager section; and
a second optical communication cabinet adjacent to the first optical communication cabinet, the second optical communication cabinet comprising:
a second rack section comprising a second plurality of housings, wherein each second housing is separate from the other second housings;
a second cable manager section adjacent to and coupled to a first side of the second rack section, the second cable manager section comprising a second plurality of cable pathways corresponding to the number of second housings such that each second cable pathway leads to the corresponding second housing; and
a second jumper manager section adjacent to a second side of the second rack section such that the second rack section is positioned between the second cable manager section and the second jumper manager section.

16. The optical communication cabinet system of claim 15, further comprising:
a first door coupled to the first optical communication cabinet, wherein the first door covers the first rack section and the first cable manager section when in a closed position;
a second door coupled to the first optical communication cabinet, wherein the second door covers the first jumper manager section in a closed position;
a third door coupled to the second optical communication cabinet, wherein the third door covers the second rack section and the second cable manager section when in a closed position; and
a fourth door coupled to the second optical communication cabinet, wherein the fourth door covers the second jumper manager section in a closed position.

17. The optical communication cabinet system of claim 15, wherein the first optical communication cabinet is adjacent to the second optical communication cabinet such that the optical communication cabinet system has a width of about 3 feet and a length of about 4 feet.

18. The optical communication cabinet system of claim 15, wherein each cable pathway of the first cable manager section and the second cable manager section comprises a lead-in section configured to guide a cable to the corresponding first housing or second housing.

19. The optical communications cabinet system of claim 15, wherein each of the first cable manager section and the second cable manager section comprises ten cable pathways and each of the first rack section and the second rack section comprises ten housings.

20. The optical communications cabinet system of claim 19, wherein each of the first housings and each of the second housings occupy a 4U space within the optical communications cabinet system.
